(19) United States
(12) Patent Application Publication
(10) Pub. No.: US 2015/0000189 A1
(43) Pub. Date: Jan. 1, 2015

(54) RAILING PLANTER

(71) Applicant: Noga Greis-Avnon, Petach Tikva (IL)

(72) Inventor: Noga Greis-Avnon, Petach Tikva (IL)

(21) Appl. No.: 14/375,797

(22) PCT Filed: Jan. 28, 2013
(86) PCT No.: PCT/IB2013/050713

§ 371 Date: Jul. 31, 2014

Related U.S. Application Data
(60) Provisional application No. 61/593,332, filed on Feb. 1, 2012.

(51) Int. Cl. A01G 9/02

(52) U.S. Cl. CPC A01G 9/02
USPC 47/66.5; 47/65.5

(57) ABSTRACT

A railing planter is disclosed comprising a body formed as a single unit having at least two tiered cavities for receiving plants and a recess for seating the planter on a railing. The railing planter may further comprise at least one connector for coupling with a matching connector of a second planter to attach the planters one to the other.

### RELATED APPLICATIONS

The present application claims the benefit under 35 U.S.C. 119(e) of U.S. Provisional Application 61/593,332 filed on Feb. 1, 2012, the disclosure of which is incorporated herein by reference.

### TECHNICAL FIELD

Embodiments of the invention relate to railing planters for displaying and growing plants on railings.

### BACKGROUND

A planter or a flower pot is a container that may be used for growing and/or displaying flowers, vegetables, herbs and/or other plants. Planters have been used throughout history, including in ancient times and are in ubiquitous use worldwide today. Conventional uses of planters include in addition to growing plants indoors and outdoors, seeding and transporting of plants.

Some planters are specifically designed to be mounted on a railing. Some such planters have one or more arms attached to them, where the arms have a recess such that the planter may hang from one side of a wall and the arms stretch over the railing and provide support from the opposing side of the wall. Other railing planters may have a recess between two legs or protrusions at the bottom of the planter for mounting on a railing with the planter body being above the railing and leg portions straddling the railing from two sides.

Planters may be made of many materials, including terracotta, clay, wood, synthetics (e.g. plastic), ceramics, metals, recycled and/or biodegradable material. At times, especially for planters that are intended for outdoor use, planters made of degradable material are treated or coated to withstand weathering.

Planters are generally formed having holes in the bottom, to allow excess irrigation water to drain out of the planter. An additional container or saucer may be placed under the planter for collecting the drain water.

### SUMMARY

An aspect of some embodiments of the invention relates to providing a tiered railing planter formed as a single unit having at least two tiered cavities for receiving plants and a recess for positioning the railing planter atop a railing. The railing may be a balcony railing, a windowsill or a top of a wall or any elongated vertical structure on top of which the railing planter may be mounted. Examples of vertical structures include partitions, for example between office cubicles, walls, fences, and cemetery headstones.

“Tiered cavities” of a planter are cavities that have openings at different elevation levels with respect to the planter bottom, allowing plants to be planted and grown at different heights, which may provide a pleasing sight. In some embodiments, a high elevation cavity is positioned between two or more low elevation cavities, thereby providing a tiered view of the planter from two sides, possibly two sides of a wall or railing atop which the planter is mounted. In some embodiments, tiered cavities are connected at their bottoms to form a shared cavity, which may allow watering one cavity of the planter via another.

A railing planter according to some embodiments comprises a clamp for clamping the planter and securing it in a position atop a railing. In some embodiments, the clamp may also serve to collect drip water from the planter.

A corner railing planter is also disclosed comprising a body formed having a cavity for receiving a plant and a curved recess for seating the planter on a curve of a railing.

In some embodiments a planter, optionally a railing planter is disclosed having at least one connector for coupling with a matching connector of a second planter to attach the planters one to the other. Such planters may be formed having a single cavity or a plurality of cavities (optionally tiered cavities).

A connector of a planter may be used for connecting a planter to a support object, thereby securing the planter in place so it will not be unintentionally dislocated with respect to the support object (e.g. when pushed or under stormy or windy conditions). Optionally a plurality of planters may be secured to each other. This may, for example, enhance the stability of a group of connected railing planters. For example, a clamp on one railing planter may be used to secure one or more other railing planters to a railing if the planters are connected (directly or indirectly) to the clamped one. Also, clamps of different connected planters may provide backup to each other in case of clamp failure.

Planters may be selected and/or mix-matched and connected to form an elongated planter of a desired length and/or shape. The connectors between the planters may stabilize the arrangement and reduce the chance of planters sliding apart. On the other hand, with appropriate connectors, planters may be separated and rearranged and/or transferred to a different location, and then reconnected.

Finally, by use of selected corner planters within a set of planters may allow attachment of a plurality of railing planters to form the appearance of a single planter following a path of a railing, including bends and curves.

Accordingly there is provided in accordance with some embodiments hereof, a railing planter comprising a body formed as a single unit having at least two tiered cavities for receiving plants and a recess for seating the planter on a railing. Optionally, the recess of the railing planter may be a curved recess for mounting the planter on a curve of a railing.

The railing planter may comprise more than two cavities. For example, the planter may have three cavities, one of which being positioned between and above two other cavities. Some or all of the cavities may be connected in their bottoms to form a shared cavity.

According to some embodiment of the invention, a planter is provided comprising a body formed having a cavity for receiving a plant, and at least one connector for coupling with a matching connector of a second planter to attach the planters one to the other. Optionally, the planter is a railing planter having a recess for positioning the planter on a railing. Optionally, the recess of the railing planter may be a curved recess for mounting the planter on a curve of a railing. Optionally, the railing planter comprises a plurality of tiered cavities for receiving plants.

According to some embodiment of the invention, a set of planters is provided comprising at least two planters, wherein at least one connector of the first planter is matching to at least one connector of the second planter such that the planters may be attached to each other by the connectors.

In some planters at least one connector is positioned in a first lateral wall of a planter and at least one connector is in an additional lateral wall of the planter, thus allowing the planter to be connected to two planters. These walls may, for example be opposing walls of the planter, such that planters may be connected linearly or positioned at an acute or right angel to each other, such that the connected planters form an angle.

According to some embodiments of the invention, a corner railing planter is provided, comprising a body formed having a cavity for receiving a plant and a curved recess for mounting the planter on a curve of a railing. Optionally, the corner railing planter may comprise at least one connector for coupling with a connector of another railing planter to lock the corner railing planter to the other railing planter.

According to some embodiments hereof a railing planter is provided, comprising a body formed having a cavity for receiving a plant, a recess for seating the planter on a railing, and at least one clamp having first and second opposed clamp jaws of which at least one is moveable towards the other to clamp the railing between them. The clamp jaw may comprise a hollow portion for holding water and a top opening. This portion may be positioned for collecting drip water from the planter. Such clamp may be included in planters as described above and below comprising connectors and/or having a curved recess and/or having a plurality of tiered cavities.

This Summary is provided to introduce in a simplified form a selection of concepts that are further described below in the Detailed Description. This Summary is not intended to identify key features or essential features of the claimed subject matter, nor is it intended to limit or define the scope of the claimed subject matter.

### BRIEF DESCRIPTION OF FIGURES

Non-limiting examples of embodiments of the invention are described below with reference to figures attached hereto. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A and 1B schematically shows perspective views of planters according to embodiments hereof.

FIGS. 2A-2G schematically show lateral views taken from an end of planters according to embodiments hereof.

FIGS. 3A-3B show cross sections of planters according to embodiments hereof.

FIGS. 4A-4E schematically show lateral views taken along the side of planters according to embodiments hereof.

FIGS. 5A-5E schematically show top views of sets of planters according to embodiments hereof.

FIGS. 6A-6C—schematically show bottom views of a corner planter according to embodiments hereof.

### DETAILED DESCRIPTION

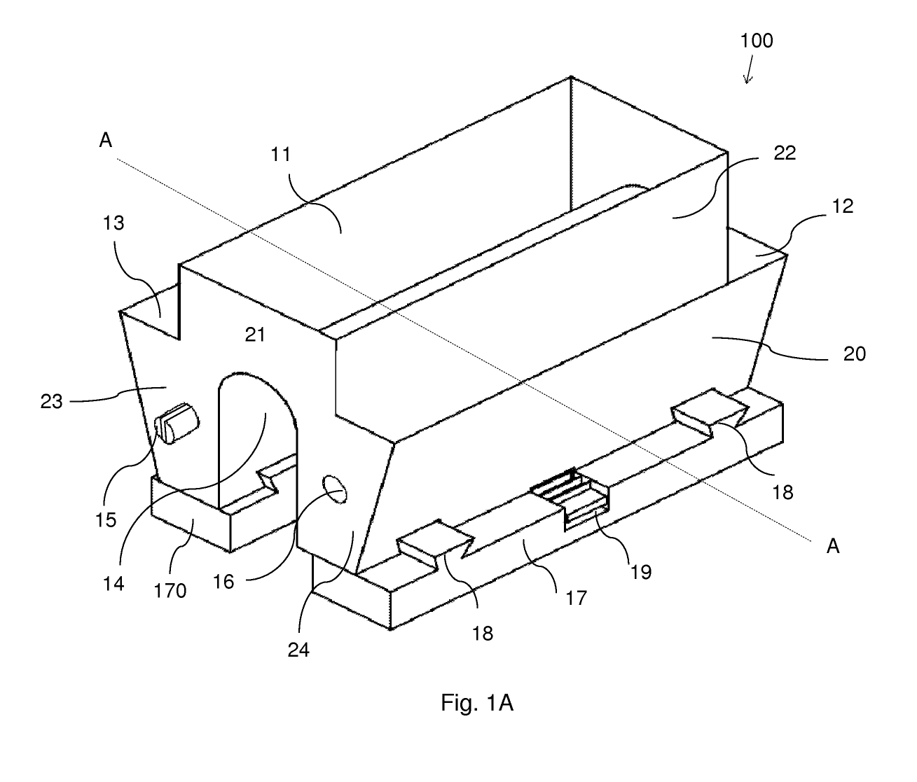

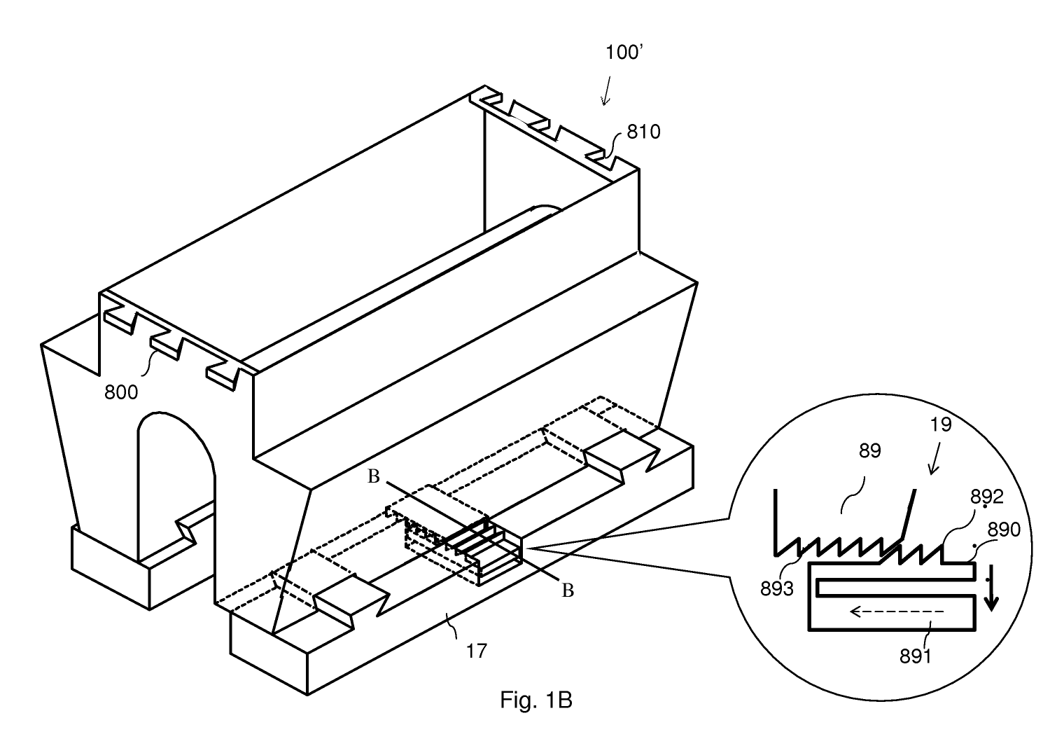

FIG. 1 Aschematically shows a perspective view of a tiered planter 100, in accordance with embodiments of the invention. Tiered planter 100, by way of example, has a body comprising a plurality of tiered cavities 11, 12 and 13. The tiered planter's body also has a recess 14 for mounting tiered planter 100 atop a railing, such that legs 23 and 24 of the planter straddle the railing. The tiered planter may be balanced on the railing due to the length and mass of legs 23 and 24. However, in accordance with some embodiments of the invention, planter 100 may also be secured to the railing using a railing clamp, which comprises first and second adjustable clamp jaws 17 and 170. Tiered planter 100 further comprises connectors 15 and 16 for attaching the planter to an object having matching connectors.

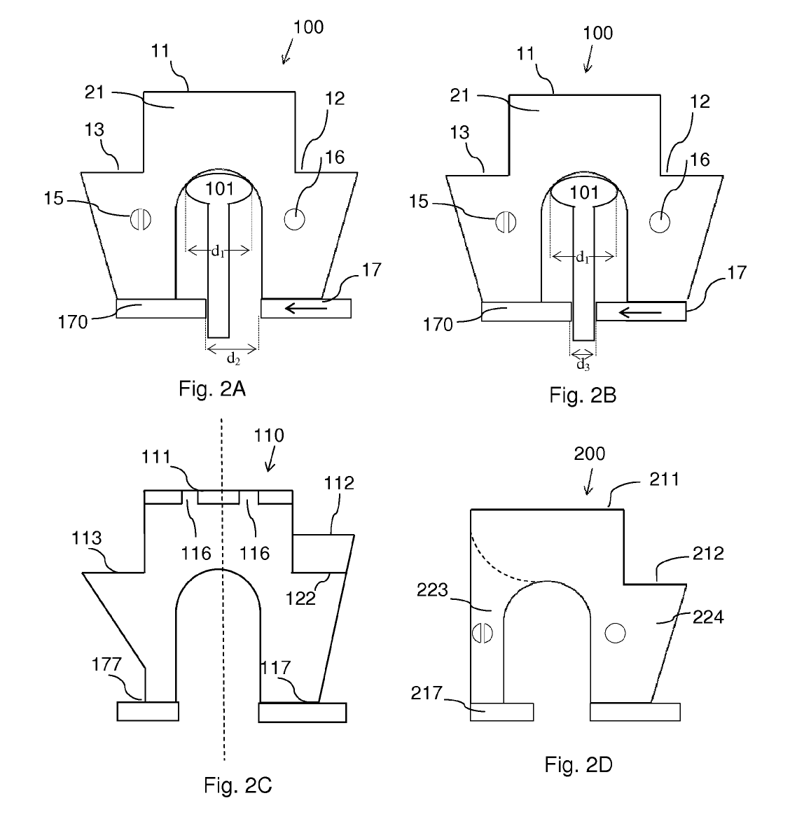

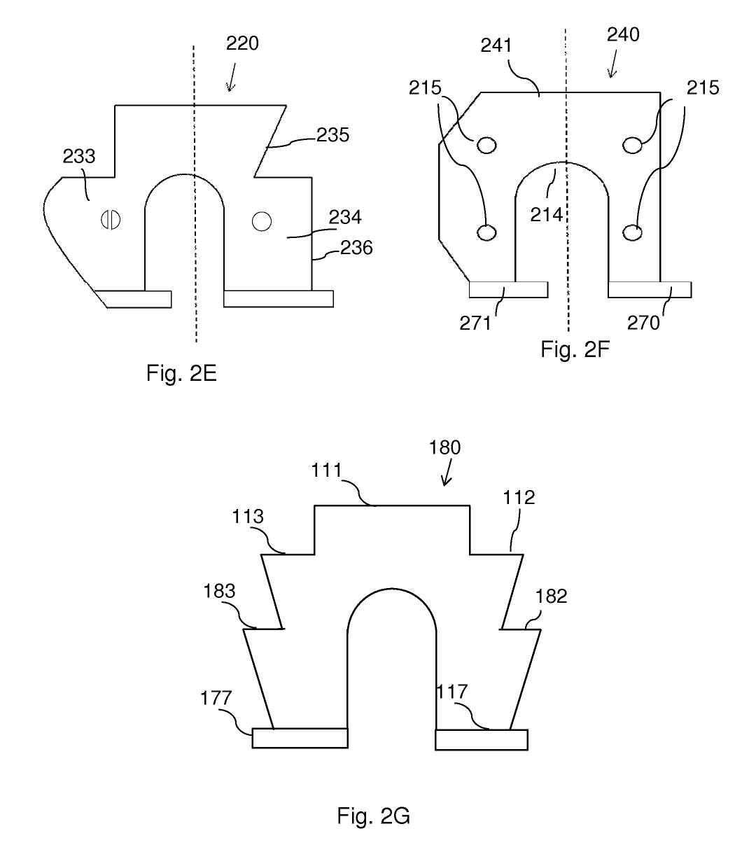

The term “tiered cavities” means that the openings of the cavities are at different elevations with respect to the bottom of the planter. In the examples shown in FIGS. 1A and 1B, cavity 11 is elevated with respect to cavities 12 and 13. Cavities 12 and 13 have a same elevation and are positioned on opposite sides of cavity 11 (see also end views in FIGS. 2A and 2B). However, other arrangements are also possible where each of the three cavities may be on a different elevation. For example, attention is drawn to FIG. 2C, where an end view of planter 110 is shown. Planter 110 has different external contours on its sides. On the right hand side of the planter a cavity 112 is shown having a lower elevation than cavity 111 which is located in the middle. On the left hand side of the planter, a cavity 113 is shown having an elevation even lower than that of cavity 112.

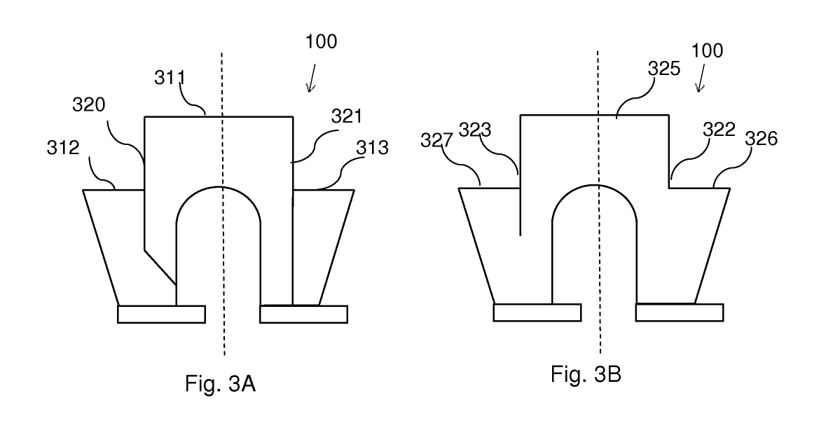

In FIG. 2C (and also FIGS. 2E, 2F, 3A and 3B), a dotted vertical line is shown between two parts of a planter that is asymmetric around the dotted line. It is noted that in all such examples a symmetric planter is also contemplated having a mirror image of one side replacing the other. Any side of a shown symmetric planter may be combined with a side of another planter to produce an asymmetric planter.

Another example for an end view of a planter is shown in FIG. 2E. Planter 220 comprises three cavities similarly to tiered planter 100 in FIG. 1A, but having different external contours. For example, leg 233 has a curved outer wall. It may be convex (as shown in FIG. 2E) or concave or S shaped or any combination thereof. Planter 220 may alternatively or additionally have straight walls that are perpendicular or angled to the ground when the planter is in an upright position (walls 236 and 235, respectively). Finally, the walls of the planter may be asymmetrical around the dashed line as shown in FIG. 2E (and FIG. 2C) and they may be symmetrical (e.g. as shown in FIG. 2A).

An end view of a planter 200 shown in FIG. 2D comprising two tiered cavities. A cavity 211 having a relatively high elevation and a cavity 212 below it. In this example, leg 224 may be a part of cavity 211 while leg 223 may be a protrusion of planter 200 that is formed with or without a cavity (e.g. the dotted line marking a wall of cavity 211). Leg 223 may for example serve to balance planter 200 and/or serve to connect a clamp to the planter.

In some embodiments, two or more cavities may be provided in sequence along a single side of a planter, for example as shown from end view in FIG. 2G. In this example, planter 180 has one central cavity 111 flanked by a sequence of two lower level cavities on each side. On one side, a mid-level elevation cavity 112 is positioned along cavity 111, similarly to cavity 12 of the tiered planter shown in FIG. 1A, but in the instant example, an additional cavity 182 having an even lower elevation is positioned along cavity 112. In the present example, this is mirrored on the other side of the planter, with a cavity 113 in mid-level elevation and a cavity 183 at a low level elevation. It is noted that more than two cavities may be positioned in sequence on a single side of a planter and that this may or may not be mirrored on the other side.

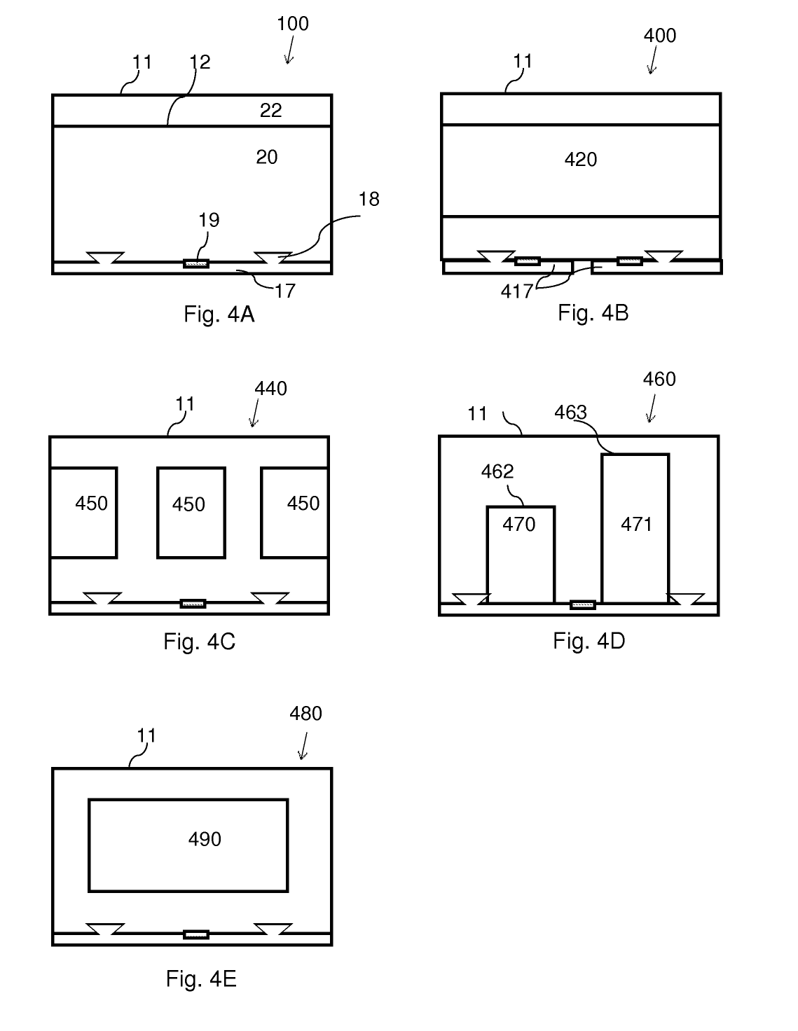

Attention is now drawn to FIGS. 4A-4E, showing side views of various planters. FIG. 4A shows tiered planter 100 according to FIG. 1A or 1B. As shown, in this example cavity 12 (or 13 of the unseen side of cavity 11) spans the full length of the planter from lend to end. Additionally, a wall 20 of cavity 12 extends from the bottom of the planter's leg 24 to the opening of cavity 12. However, many alternatives may also be made.

For example, in FIG. 4B, a wall 420 of a low elevation cavity spans the length of a planter 400 from end to end (like wall 20 in FIG. 4A) but the bottom of this wall is positioned at a level higher than the bottom of the planter, forming essentially a hanging pocket along the side of the planter. This can be seen also from end view in FIG. 2C, showing cavity 113 on the left hand side of cavity 111. Another example, shown in FIG. 4E discloses a single low cavity on the side of a planter 480, having a wall 490. This wall is shorter than the length of the planter and has a bottom positioned at a level higher than the bottom of the planter.

In some embodiments a plurality of cavities may be provided along a single side of a planter. Some examples for such cavity arrangement are shown from a side view in FIGS. 4C and 4D. In FIG. 4C three cavities 450 are positioned along cavity 11. Each of the cavities 450 has a top opening at the same elevation with respect to the bottom of a planter 440 and a high bottom (similarly to wall 420 in FIG. 4B).

In FIG. 4D two cavities 470 and 471 are positioned along cavity 11. Cavity 470 has a top opening 462 and cavity 471 has a top opening 463. Top opening 461 is at a higher elevation than top opening 462 and both are below the top of planter 440 and the opening of cavity 11. A similar planter arrangement is presented from end view in FIG. 2C, where a low elevation side cavity 122 is shown together with the high elevation side cavity 112 at the right hand side of planter 110.

Attention is now drawn to some optional internal configurations shown in the cross sectional views of FIGS. 3A and 3B. These cross sections are taken along dashed line A-A of FIG. 1. In these cross sectional views, planter 100 is shown with examples for the inner divisions between the planter's cavities.

Two abutting cavities may, for example, be completely separated one from the other. For example, as shown in FIG. 3A, an upper cavity 311 may be formed between walls 321 and 320. Wall 321, for example, extends along a cavity 313 all the way to the bottom of planter 100. In an alternative arrangement wall 320 completely separates cavity 311 from cavity a 312 without reaching the bottom of the planter. It is noted, that even when the cavities are completely separated, holes and/or perforation and/or other passages may exist in separating walls (wall 320 or wall 321), to allow for example passage of water from one cavity to the other.

Alternatively, two or more cavities in a planter may be joined to form a single cavity, as shown for example in FIG. 3B. In this example a high level cavity 325 is formed between walls 322 and 323. These walls separate cavity 325 from lower cavities 326 and 327 only partially thereby combining them to a single more complex cavity. This allows soil and/or water to move between cavities when the planter is filled and/or emptied and for watering.

A railing planter may comprise one or more clamps to secure it in position atop a railing as shown for example in FIGS. 1A and 1B, comprising clamp jaws 17 and 170. In the present context, clamp means an element that is capable of securing a railing planter in position atop a railing by narrowing the distance under the recess. For example, the clamp may secure the planter in position by pressing against a wall under the railing from one or two sides by one or more clamp jaws. When the railing is atop a wall that is not continuous (e.g. vertical bars of a balcony), clamp jaws from two legs of a planter may be able to contact each other across the wall and optionally connect at a site of contact (e.g. by connectors as used to connect planters to each other). Finally, the clamp jaws may secure the planter in position by virtue of reducing the opening of the recess to a width that is narrower than that of the railing.

An example for a clamp is shown as clamp jaws 17 and 170 in FIG. 1A. Clamp jaws may also be seen from end views in FIGS. 2A-2E and side views 4A-4E. In the shown example, clamp jaw 17 and clamp jaw 170 are connected to the body of planter 100 via dovetail connectors 18, but any other arrangement that would allow the clamp jaw to dislocate along the bottom the planter's leg and towards the other leg may be used. This allows clamp jaw 17 to slide towards clamp jaw 170 (and/or vice versa). This sliding motion is depicted schematically in FIGS. 2A (with clamp jaw 17 in an open position) and 2B (with clamps jaws 17 and 170 in the closed position).

In the example, clamp jaw 170 was stationary and clamp jaw 17 slid in the direction of the shown arrow from to a closed position. In an open position (FIG. 2A) the distance between the clamp jaws is d2 and the maximal width of the railing is d1. For mounting (or dismounting), at least one clamp jaw needs to be moved to an open or partially open position such that the opening of the planter's recess d2 will be larger than the width of the railing d1.

A latch 19 may be configured to lock clamp jaw 17 in position after sliding it from an open position (FIG. 2A) to a closed position (FIG. 2B) or one of a plurality of in-between positions. The mechanism of latch 19 is shown in cross section FIG. 1B of tiered planter 100′. The latch comprises a bottom portion 891 which in the example is part of the bottom of clamp 17 and a teeth portion 890. Teeth portion 890 is flexible and may angle down when pressure is applied as depicted by a bold arrow. Teeth portion 890 comprises one or more teeth 892. A top portion 89 is embedded in the bottom of the leg of planter 100′. It comprises one or more teeth 893. Teeth 893 and teeth 892 are angled with respect to each other such that when bottom portion 891 is pushed in the direction of the dashed arrow, the teeth slide respective each other and, together with the flexibility of top portion 89, allow clamp jaw 17 to slide as pushed. The teeth are also so angled such that clamp jaw cannot move against the direction of the dashed arrow unless teeth portion 890 is depressed in the direction of the bold arrow.

Clamp jaw 170 may be stationary or capable of sliding in the direction of clamp jaw 17, in which case it too may have a locking mechanism such as latch 19. When clamp jaws 17 and 170 are in a closed or partially closed position, they may grip the railing from below, thereby securing the planter in position. The distance between the clamp jaws in a closed position (d3 as shown in FIG. 2B) may be shorter than the maximal width of the railing (d1). This too may assist in securing the planter and preventing it from falling off the railing. One or more of clamp jaws 17 and 170 may have a plurality of locked positions, between the two shown in FIGS. 2A and 2B, thereby allowing a railing planter to be mounted and secured on walls or railings of a plurality of widths.

Latch 19 may be used to remove the planter. By pressing the latch, the clamp becomes unlocked and at least one of clamp jaws 17 and 170 may be slid to the open position thereby allowing removal of the railing planter.

Clamp jaws 17 and/or 170 may also serve to collect drip water exuded from the planter. The clamp jaw may be formed having a hollow portion for holding water and the top of a clamp jaw may comprise one or more holes or openings (not shown). These holes or openings may be positioned to collect drip water from holes or openings in the bottoms of legs 23 and 24 of tiered planter 100 (not shown). For example—a major portion of the top of a clamp jaw may be open or perforated thereby fitting under any hole in the bottom of a planter leg. This may allow excess irrigation water to drip away from the planter and into the clamp, without causing unwanted wetness or soiling under the planter.

Finally, a clamp may comprise two or more opposed units on opposed planter legs. They may span the entire length of a leg (e.g. see side view in FIG. 4A) or one or more sorter clamp jaws (417) may be present on a single leg as shown for example from side view in FIG. 4B.

As shown in FIG. 1A, tiered planter 100 may have male and female connectors 15 and 16 respectively for attaching the planter to an object having matching connectors. This may, for example, be an additional planter. “Connectors” may be any kind of physical structures capable of coupling together to attach the two objects one to the other. “Matching” connectors are connectors that have matching structure and/or composition and/or dimensions allowing them to attach one to the other. In the example shown in FIG. 1A, the connectors include a male (protruding) connector 15 and a female (indented) connector 16. Matching pairs of male and female connectors may snap and/or lock one to the other, for example pressing end surfaces of two planters towards each other. The male and/or female connectors may have in them additional grooves and/or indentations and/or protrusions for securing the members in a locked position.

In some embodiments the matching male and female connectors may include grooves and/or slots and or protrusions that are intended to be slid one into the other, for example as the dovetail connectors 18 shown in FIG. 1A between the planter body and clamp jaw 17. An example for such an arrangement is shown in FIG. 1B. A male dovetail connector 800 may be connected to a female dovetail connector 810 from a different planter.

It is noted that connectors need not necessarily protrude significantly from the surface in which they are positioned and may include a plurality of very small members (e.g. Velcro like loop and hook arrangements) or they need not protrude at all (e.g. magnets).

In some embodiments of the invention, a planter having connectors on a lateral wall thereof might have a single cavity and/or not include a recess for mounting on a railing. An example for one such embodiment is shown from an end view in FIG. 2F. In this example a planter 240 is formed having a single cavity 241 (or a plurality of non-tiered cavities). The planter is shown with a recess 214, but planters without a recess are also contemplated. In this example, two alternative lateral contours are shown as examples, and the planter may or may not be symmetrical across the dashed line separating the shown contours. If embodiments where planter 240 comprises recess 214 it may optionally comprise clamp jaws 470 and 471 as shown.

While FIG. 1A depicts tiered planter 100 having one male connector 15 and one matching female connector 16 both on the same wall 21 of the planter, it is noted that many variations are contemplated to be with the scope of some embodiments of the invention. Examples include having only a single connector on a given wall or having any number of connectors on the wall (see for example FIG. 2F schematically showing four connectors 215 (either male or female or any other type of connector) on wall 241 of planter 240, which planter has a single cavity for receiving a plant.

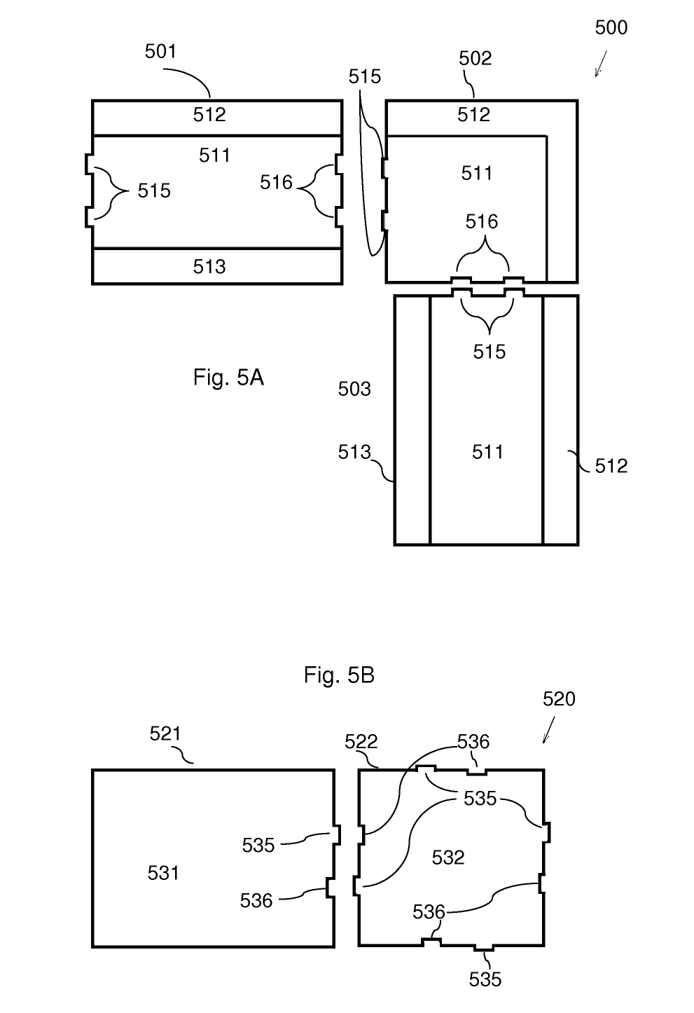

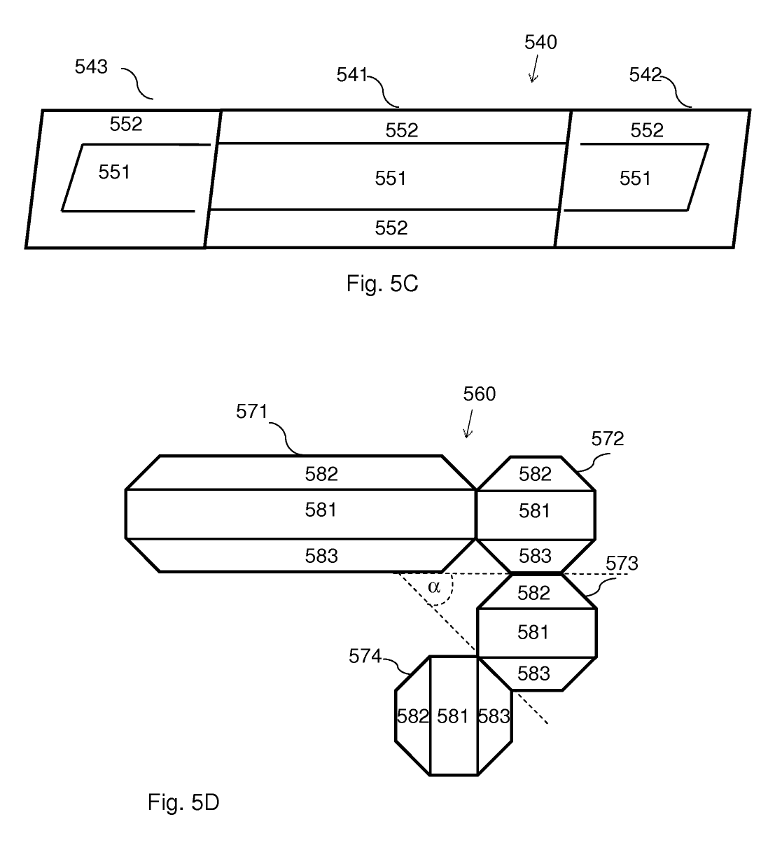

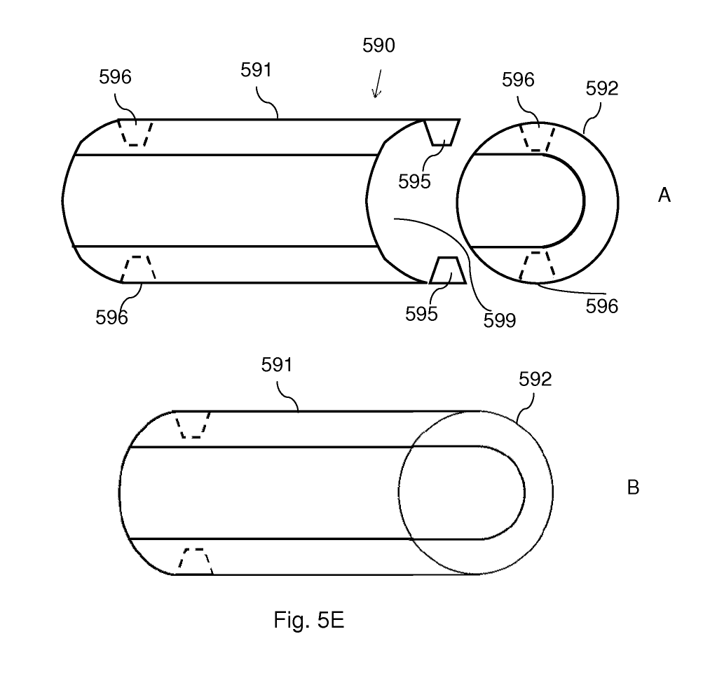

Additionally or alternatively, planters may have connectors on more than one wall, making it possible to connect them to a plurality of other planters or objects. For example—when a planter has connectors positioned to allow the connection of planters from two opposing directions (e.g. see a top view of a planter 501 in FIG. 5A having male connectors 515 and female connectors 516 or a planter 591 in FIG. 5E, having male connectors 595 and female connectors 596) the planter may be connected between two other planters.

Additionally or alternatively, a planter may have connectors positioned to attach the planter to objects in non-opposing direction (namely walls that are at an acute or right angle to each other). Examples for such planters include planters having connectors on two sides (e.g. planter 502 in FIG. 5A) and planters that may be attached to three or more additional planters (e.g. planter 522 in FIG. 5B having connectors on 4 sides, each side having at least one male connector 535 and at least one female connector 536). In some cases, a planter may be attached to two planters at directions having an acute angle between them as shown for example in FIG. 5D with a planter 573 connected to planters 572 and 574 (see angle a between the dotted lines extending from the connected walls). In this figure, the connectors are not visible.

It is noted that connectors may be on a planter wall facing the direction of a second planter (e.g. a direction along a railing on which the planters are mounted), for example as shown in a planter 503 of FIG. 5A. Additionally or alternatively, connectors may be positioned elsewhere as long as connection may be made in the desired direction. An example is shown in FIG. 5E wherein connectors 595 are positioned on planter 591 in a traverse direction to the direction of planter 592 to which they are to be connected via connectors 596. This may be achieved for example if connectors 595 are on a flexible or hinged surface that allows pressing planter 592 into lateral recess 599 of planter 591 and then the pressing or clicking of male connectors 595 into female connectors 596.

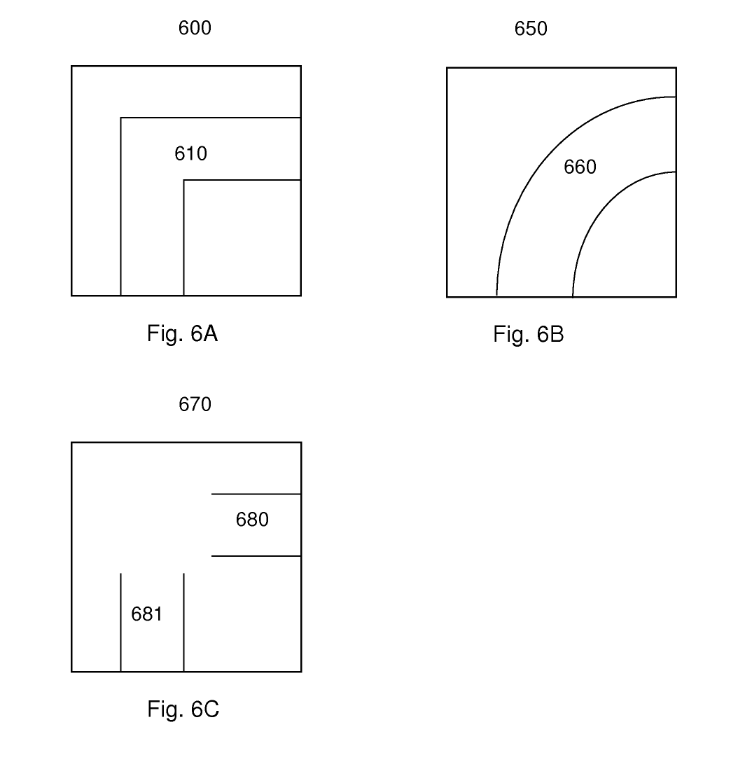

At times, a planter may need to be mounted on a curved railing (or a corner of a railing or wall). This is a portion of a wall or railing that extends in a non-linear direction in from a top view. The curved railing may be parallel to the ground or may be slanted with respect to ground level at the area of the curve. Corner planters are planters configured to be mounted on such curves. They may have a curved recess capable of accepting and optionally clamping a matching curved railing (e.g. an angled or a smooth curve). Examples for planter recesses are shown in FIGS. 6A-6C.

In FIG. 6A a railing planter 600 comprises a right angled recess 610. In FIG. 6B, a planter 650 comprises a curved recess 660. At times the recess may be non-continuous as shown in FIG. 6C, where a planter 670 has a curved recess comprising two recesses—680 and 681. A person skilled in the art of the invention would appreciate that the recess may have any other curves and/or angles as needed as long as it may match a railing's shape.

Corner planters may be standalone planters (e.g. having no connectors on their surface) or they may have connectors on one or more surfaces allowing attachment to other planters from one or more directions. Examples may include planter 502 in FIG. 5A having tiered cavities 511 and 512 and planter 522 in FIG. 5B having a single cavity 532 and planters 572 and 573 in FIG. 5D each having three tiered cavities (581, 582 and 583) and planter 592 in FIG. 5E. An example of an end view of a planter such as planter 502 in FIG. 5A is the planter 240 shown in FIG. 2D.

According to some aspects hereof sets of planters (optionally sets of railing planters) are disclosed. The sets may comprise two or more of the following planter kinds. Optionally at least two of the planters are of the same kind or of different kinds.

An “edge planter”—having connectors that allow attachment of the planter to one other planter from a single side of the edge planter.

An “in-between planter”—having connectors that allow attachment of the planter to two or more other planters from at least two sides of the in-between planter. Such planters may be “train planters” that are connectable only on opposing sides (like railroad cars in a train). Alternatively, in-between planters may be junction “planters” that have connectors to enable connection of the junction planter to a plurality of planters at least from two non-opposing sides.

Examples for sets of planters having different top views and potentially different connectors appear in FIGS. 5A-5E. These planters may or may not be railing planters.

FIG. 5A shows a set of multi-cavity (optionally tiered) planters comprising a train planter 501 and a junction planter 511 each similar to planter 100 of FIG. 1 and having three cavities (511, 512 and 513), and junction planter 502. Junction planter 502 shows two cavities (511 and 512) which may be tiered, as shown in FIG. 2C (end view).

FIG. 5B shows a set of single cavity planters 521 and 522, each having a single cavity (531 and 532, respectively). Planter 522 is an example for an in-between planter (or junction planter) connectable on 4 lateral walls.

FIG. 5C discloses a set of three tiered planters each having an elevated cavity 551 and one or more lower cavities 552. This set is shown with train planter 541 between two edge planters 542 and 543. The length of the combined set may be selected according to the number of train planters used between the edge units as well as the lengths of each of the planters.

In FIG. 5D a set of four planters is shown. The planters are shown with each having three cavities, 581, 582 and 583 which may be tiered. Each of the planters in FIG. 5D has 8 walls which may or may not be equal in length. This may allow connecting planters in directions other than a right angle to junction planters, as seen for example with planter 573 (connectors not shown). This may allow a set of planters to follow a varying curve, and in the case of railing planters—a varying curve on a railing.

FIG. 5E discloses two members of a set of planters having curved edge surfaces. Train planter 591 is attachable to edge planter 592. An additional train planter 591 may be attached to the other side of planter 591 via connectors 596. A train planter such as planter 591 may be also used as an edge planter (e.g. with connectors 596 hidden) or an edge planter may be manufactured being similar to train planter 591 but lacking connectors 596.

Planters according to some embodiments may be made of any material known in the art for the manufacture or industrial manufacture of planters. Accordingly known methods of manufacture for planter may be employed including manual or industrial clay or terracotta molding, injection molding or thermal forming of plastics, etc. The planter body may be manufactured as a single unit (e.g. a single planter comprising at least two cavities) with the connectors and/or clamp jaws produced separately and attached later.

The planter may include any and all features known in the art to be included for planters including components used for watering and/or a water reservoir to allow longer periods between watering and/or means for removal of excess water (e.g. holes, and/or messes and/or valves at the bottom of the planter or within the planter).

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

In the discussion, unless otherwise stated, adjectives such as “substantially”, “essentially” and “about” modifying a condition or relationship characteristic of a feature or features of an embodiment of the invention, are understood to mean that the condition or characteristic is defined to within tolerances that are acceptable for operation of the embodiment for an application for which it is intended.

Descriptions of embodiments of the invention in the present application are provided by way of example and are not intended to limit the scope of embodiments of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A railing planter comprising a body formed as a single unit having at least two tiered cavities for receiving plants and a recess for seating the planter on a railing.

2. The railing planter of claim 1, wherein the at least two tiered cavities comprise three cavities.

3. The railing planter of claim 2, wherein one of the at least two tiered cavities is positioned between and above two other cavities.

4. The railing planter of claim 2, wherein a plurality of the at least two tiered cavities are connected in their bottoms to form a shared cavity.

5. The railing planter of claim 1, having at least one connector for coupling with a matching connector of a second planter to attach the planters one to the other.

6. The railing planter of claim 1, wherein the recess is a curved recess for mounting the planter on a curve of a railing.

7. The railing planter of claim 1, having at least one clamp having first and second opposed clamp jaws of which at least one is moveable towards the other to clamp the railing between them.

8. The railing planter of claim 1, wherein at least one clamp jaw is formed having a hollow portion for holding water and a top opening.

9. A planter comprising:
a body formed having a cavity for receiving a plant; and
at least one connector for coupling with a matching connector of a second planter to attach the planters one to the other.

10. The planter of claim 8, having a recess for positioning the planter on a railing.

11. The planter of claim 10, having at least one clamp having first and second opposed clamp jaws of which at least one is moveable towards the other to clamp the railing between them.

12. The planter of claim 11, wherein at least one clamp jaw is formed having a hollow portion for holding water and a top opening.

13. The planter of claim 8, wherein at least one connector is positioned in a first lateral wall of the planter and at least one connector is in an additional lateral wall of the planter.

14. The planter of claim 13, wherein the first lateral wall and the second lateral wall are opposing walls of the planter.

15. The planter of claim 13, wherein the first lateral wall and the second lateral wall are walls of the planter positioned at an acute or right angle to each other.

16. A set of planters comprising a first planter according to claim 8 and a second planter according to claim 8, wherein at least one connector of the first planter is matching to at least one connector of the second planter such that the planters may be attached to each other by the connectors, and wherein at least one of the planters is a middle planter comprising two sets of connectors for coupling to connectors of two planters at opposing sides of the middle planter.

17. (canceled)

18. A set of planters comprising a first planter according to claim 8 and a second planter according to claim 8, wherein at least one of the planters is a junction planter comprising two sets of connectors for coupling to matching connectors of two planters at non opposing sides of the junction planter.

19. A set of planters comprising a first planter according to claim 8 and a second planter according to claim 8, wherein at least one of the planters is an edge planter comprising a single set of connectors for coupling to a planter only on one side of the edge planter.

20. (canceled)

21. (canceled)

22. A corner railing planter comprising a body formed having a cavity for receiving a plant; a curved recess for mounting the planter on a curve of a railing; at least one clamp having first and second opposed clamp jaws of which at least one is moveable towards the other to clamp the railing between them and wherein at least one clamp jaw is formed having a hollow portion for holding water and a top opening.

23. The corner railing planter of claim 22, comprising at least one connector for coupling with a connector of another railing planter to lock the corner railing planter to the other railing planter.

24. (canceled)

25. (canceled)

26. (canceled)

27. (canceled)
